(19) United States
(12) Patent Application Publication
(10) Pub. No.: US 2025/0252524 A1
(43) Pub. Date: Aug. 7, 2025

(54) REORDERING CHAINS OF PRODUCING AND CONSUMING WORKLOADS TO EXPLOIT GPU MEMORY RESIDENCY

(71) Applicant: QUALCOMM Incorporated, San Diego, CA (US)

(72) Inventors: Alec Matthew SHERAN, Franklin, MA (US); Tate HORNBECK, Cambridge, MA (US)

(21) Appl. No.: 18/434,738

(22) Filed: Feb. 6, 2024

(51) Int. Cl. G06T 1/20; G06T 1/60

(52) U.S. Cl. CPC G06T 1/20; G06T 1/60

(57) ABSTRACT

This disclosure provides systems, devices, apparatus, and methods, including computer programs encoded on storage media, for reordering chains of producing and consuming workloads to exploit GPU memory residency. A processor obtains an indication of a set of graphics processor workloads that are to be executed by a graphics processor in an execution order. The processor determines that a first subset of graphics processor workloads in the set of graphics processor workloads produces a set of resources in graphics memory and that a second subset of graphics processor workloads in the set of graphics processor workloads consumes the set of resources in the graphics memory. The processor alters, based on the determination, the execution order such that a first index of the first subset occurs within a threshold index separation from a second index of the second subset. The processor outputs an indication of the altered execution order.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques associated with graphics processor workloads may be associated with resources being evicted off-chip. There is a need for improved techniques pertaining to an execution order of graphics processor workloads.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: obtain an indication of a set of graphics processor workloads that are to be executed by a graphics processor in an execution order; determine that a first subset of graphics processor workloads in the set of graphics processor workloads produces a set of resources in graphics memory and that a second subset of graphics processor workloads in the set of graphics processor workloads consumes the set of resources in the graphics memory; alter, based on the determination, the execution order of the set of graphics processor workloads such that a first index of the first subset of graphics processor workloads occurs within a threshold index separation from a second index of the second subset of graphics processor workloads; and output an indication of the altered execution order.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 is a diagram illustrating an example of a GPU and an example of system memory in accordance with one or more techniques of this disclosure.

FIG. 5 is a diagram illustrating an example of a natural order of graphics processor workloads in accordance with one or more techniques of this disclosure.

FIG. 6 is a diagram illustrating an example of reordered graphics processor workloads in accordance with one or more techniques of this disclosure.

FIG. 7 is a diagram illustrating an example of reordering graphics processor workloads using weights in accordance with one or more techniques of this disclosure.

FIG. 8 is a diagram illustrating example aspects pertaining to reordering graphics processor workloads in accordance with one or more techniques of this disclosure.

FIG. 9 is a call flow diagram illustrating example communications between a first graphics processor component and a second graphics processor component in accordance with one or more techniques of this disclosure.

FIG. 10 is a flowchart of an example method of graphics processing in accordance with one or more techniques of this disclosure.

FIG. 11 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

An application (e.g., a video game application) may submit workloads to a GPU driver of a GPU in an order that is suitable for the application. The GPU driver may also be referred to as a graphics processor driver. A graphics processor driver may refer to software that facilitates communication between a graphics processor (e.g., a GPU) and an application running on a CPU. However, the application may not have information about a suitable order of execution of the workloads for the GPU. Thus, the order in which the workloads are submitted may result in resources associated with the workloads being evicted off-chip from the GPU. Reading/writing resources off-chip may increase power consumption of the GPU and/or may result in decreased performance (e.g., an increased latency, a decreased frame rate, etc.).

Various technologies pertaining to reordering chains of producing and consuming workloads to exploit GPU memory residency are described herein. In an example, an apparatus (e.g., a GPU, a GPU driver executed by a CPU, etc.) obtains an indication of a set of graphics processor workloads that are to be executed by a graphics processor in an execution order. An execution order may refer to an order in which graphics processor workloads are to be executed. The apparatus determines that a first subset of graphics processor workloads in the set of graphics processor workloads produces a set of resources in graphics memory and that a second subset of graphics processor workloads in the set of graphics processor workloads consumes the set of resources in the graphics memory. Resources may refer to data that is used to facilitate the presentation of graphics content on a display. Graphics memory may refer to on-chip memory of a graphics processor. The apparatus alters, based on the determination, the execution order of the set of graphics processor workloads such that a first index of the first subset of graphics processor workloads occurs within a threshold index separation from a second index of the second subset of graphics processor workloads. The apparatus outputs an indication of the altered execution order. Vis-à-vis altering, based on the determination, the execution order of the set of graphics processor workloads such that a first index of the first subset of graphics processor workloads occurs within a threshold index separation from a second index of the second subset of graphics processor workloads, the apparatus may reduce an amount of resources that are read or written off-chip, which may reduce a power consumption of the apparatus and/or may increase performance (e.g., decreased latency, increased frame rates, etc.) of the apparatus.

Some GPU architectures may have limited on-chip, fast access memory for improved power and performance. Applications may submit their respective workloads in a particular order that makes sense for purposes of the applications, but with no knowledge of how a GPU driver may most optimally maintain resources in on-chip memory to prevent the resources from going off-chip. In one aspect described herein, GPU workloads may be reordered to produce and consume the same resources into a more tightly coupled sequence. In this way, applications may submit their work in any natural order. The GPU driver may generate a workload dependency graph to gain an understanding of resource producers and consumers, and then move consumers as close to producers as possible, while preserving functional ordering, that is, a workload that uses a resource may not be reordered before its producer. The reordering scheme described herein may achieve an increase in an amount of bytes kept on-chip in some game captures, which may improve performance.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

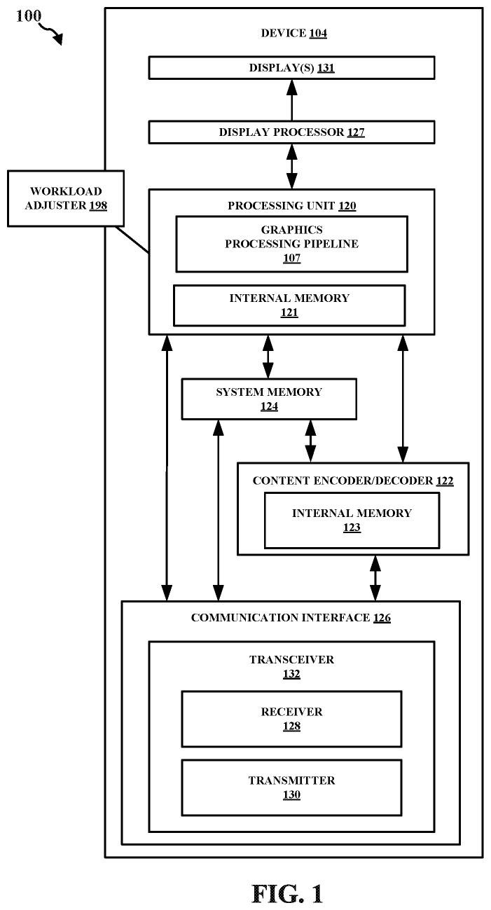

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a workload adjuster 198 configured to obtain an indication of a set of graphics processor workloads that are to be executed by a graphics processor in an execution order; determine that a first subset of graphics processor workloads in the set of graphics processor workloads produces a set of resources in graphics memory and that a second subset of graphics processor workloads in the set of graphics processor workloads consumes the set of resources in the graphics memory; alter, based on the determination, the execution order of the set of graphics processor workloads such that a first index of the first subset of graphics processor workloads occurs within a threshold index separation from a second index of the second subset of graphics processor workloads; and output an indication of the altered execution order. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

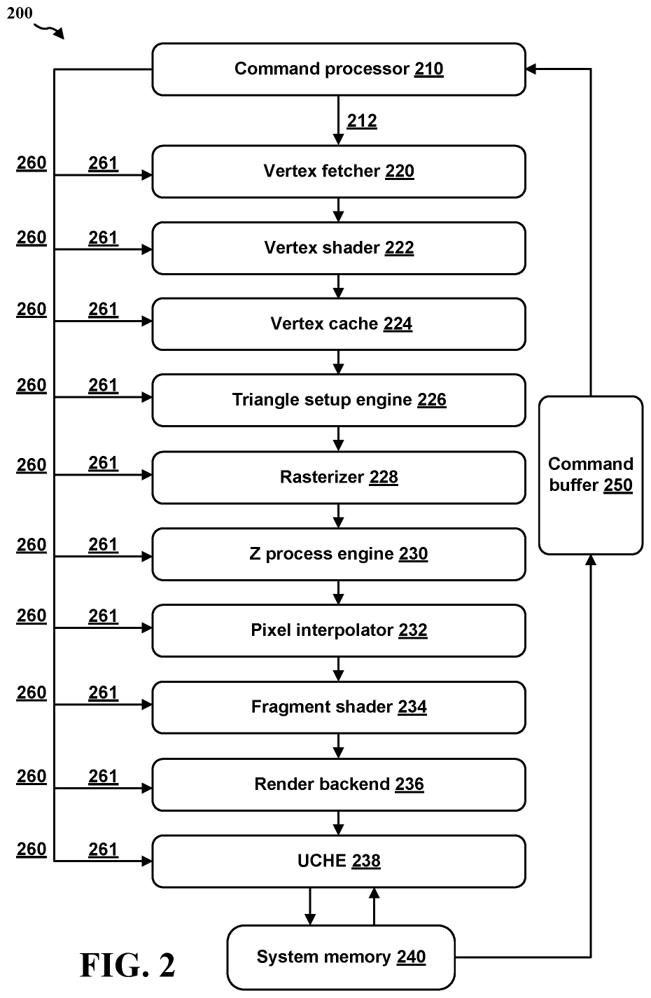

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

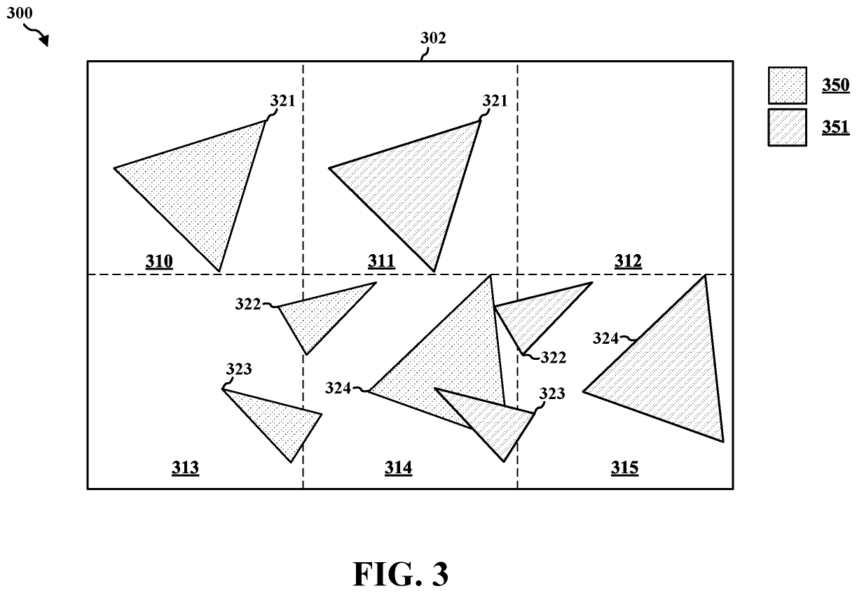

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

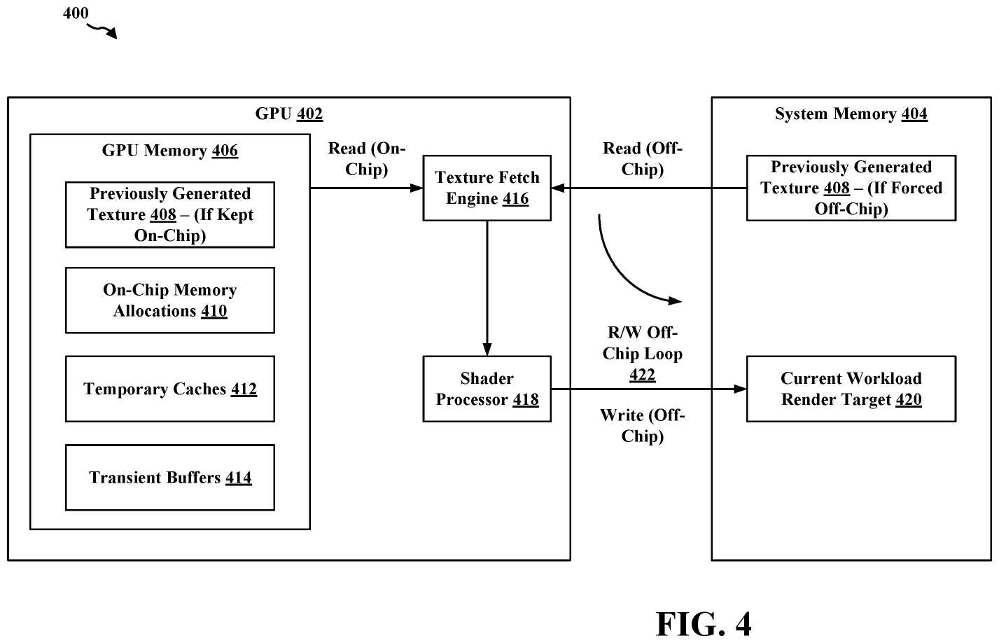

FIG. 4 is a diagram 400 illustrating an example of a GPU 402 and an example of system memory 404 in accordance with one or more techniques of this disclosure. In an example, the GPU 402 and the system memory 404 may be included in the device 104. System memory may refer to memory (e.g., memory at a graphics processor or GPU 402) that is not on-chip graphics memory. In an example, the GPU 402 may be included in the processing unit 120 (e.g., in the graphics processing pipeline 107). In an example, the system memory 404 may be or include the system memory 124. In an example, the GPU 402 may be or include the GPU 200. In an example, the system memory 124 may be or include the system memory 240. In an example, the GPU 402 may access the system memory 404 via a bus (not depicted in FIG. 4).

The GPU 402 may include GPU memory 406. The GPU memory 406 may alternatively be referred to as GMEM. In an example, the GPU memory 406 may be or include the internal memory 121. The GPU memory 406 may store a previously generated texture 408 (if kept on-chip). Additionally, or alternatively, the system memory 404 may store the previously generated texture 408 (if forced off-chip). The previously generated texture 408 may be referred to as a resource. The GPU memory 406 may also include on-chip memory allocations 410, where the on-chip memory allocations 410 may be used to stored textures or other data. The GPU memory 406 may also include/store temporary caches 412 and transient buffers 414. The temporary caches 412 and/or the transient buffers 414 may store data that facilitates the display of graphics content.

The GPU 402 may include a texture fetch engine 416. The texture fetch engine 416 may read (i.e., fetch) textures. In one example, the texture fetch engine 416 may read the previously generated texture 408 from the GPU memory 406 if the previously generated texture 408 is kept on-chip. In another example, the texture fetch engine 416 may read the previously generated texture 408 from the system memory 404 if the previously generated texture 408 is forced off-chip. Reading the previously generated texture 408 from the GPU memory 406 may take a first amount of time and reading the previously generated texture 408 from the system memory 404 may take a second amount of time, where the second amount of time may be greater than the first amount of time. Stated differently, reading the previously generated texture 408 from the GPU memory 406 may be faster than reading the previously generated texture 408 from the system memory 404 due to the GPU memory 406 being “on-chip” and/or due to different characteristics of the GPU memory 406 and the system memory 404. In an example, the GPU memory 406 may have a first size and the system memory 404 may have a second size, where the first size is less than the second size. In an example, the GPU memory 406 may have a first RAM speed and the system memory 404 may have a second RAM speed, where the first RAM speed is greater than the second RAM speed. A RAM speed may refer to a rate at which data (e.g., a texture) may be read or written to memory (e.g., the GPU memory 406, the system memory 404). In an example, reading the previously generated texture 408 from the GPU memory 406 may consume a first amount of power and reading the previously generated texture 408 from the system memory 404 may consume a second amount of power, where the first amount of power is less than the second amount of power. In an example, reading the previously generated texture 408 from the system memory 404 may entail the activation of input/output (I/O) blocks (not depicted in FIG. 4), which may cause the second amount of power to be consumed.

The GPU 402 may include a shader processor 418. The shader processor may be configured to execute shaders. A shader may refer to a program designed to execute a graphics processor (e.g., the GPU 402). In an example, the texture fetch engine 416 may provide the previously generated texture 408 (read from the GPU memory 406 or the system memory 404) to the shader processor 418, and the shader processor 418 may execute a shader on the previously generated texture 408. In an example, executing the shader may produce a current workload render target 420. In the example, the shader processor 418 may write the current workload render target 420 to the system memory 404. The process of (1) the texture fetch engine 416 reading the previously generated texture 408 from the system memory 404, (2) the texture fetch engine 416 providing the previously generated texture 408 to the shader processor 418, (3) the shader processor 418 executing a shader to produce the current workload render target 420, and (4) the shader processor 418 writing the current workload render target 420 to the system memory 404 may be referred to as a read/write (R/W) off-chip loop 422.

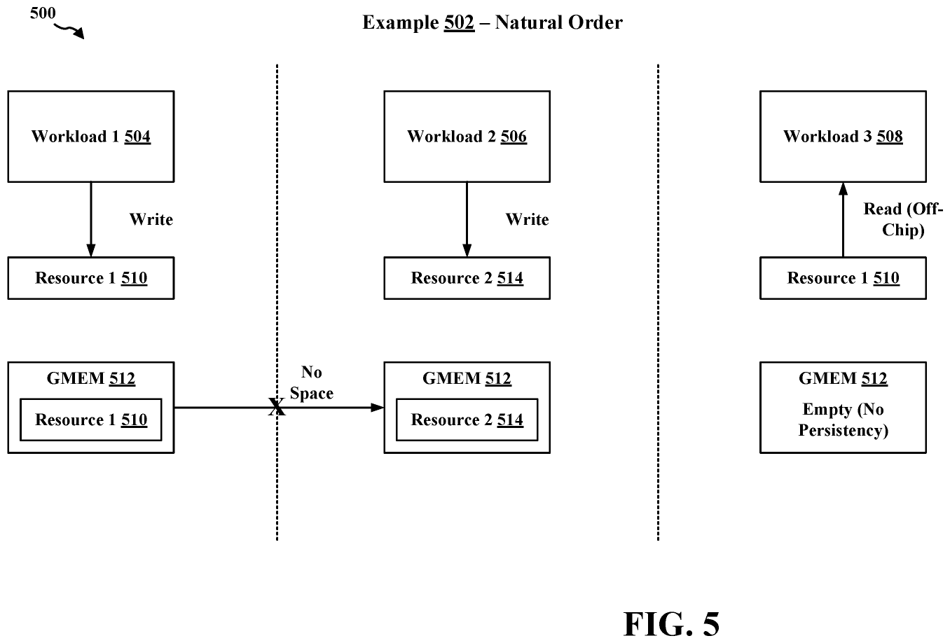

FIG. 5 is a diagram 500 illustrating an example 502 of a natural order of graphics processor workloads in accordance with one or more techniques of this disclosure. A GPU (e.g., the GPU 402) may operate within a power budget with a goal. In an example, the goal of the power budget may be to preserve battery life in a mobile environment (i.e., preserve battery life of a device that includes the GPU). In another example, the goal of the power budget may be to prevent performance throttling of the GPU due to heat generated by the GPU when a device that includes the GPU is coupled to (i.e., “hooked”) to a power supply. Reducing a number of off-chip transactions may reduce an amount of power consumed by a GPU. An off-chip transaction may refer to a process of a GPU reading or writing data from/to memory external to the GPU (e.g., the system memory 404). An on-chip transaction may refer to a process of a GPU reading or writing data from/to memory of the GPU (e.g., the GPU memory 406). A GPU 402 may access data in a faster manner via on-chip transactions compared to data accessed via off-chip transactions. In an example, a GPU that performs an off-chip transaction may active I/O blocks, which may cause data accessed by the off-chip transaction to be accessed in a slower manner than data accessed by an on-chip transaction. Data that is accessed faster (e.g., via an on-chip transaction) may be associated with improved performance at the GPU. For example, data that is accessed faster may be associated with reduced power consumption, higher frame rates, higher resolutions, etc.

Some GPU architectures may provide on-chip, fast access memory (e.g., the GPU memory 406) in order to facilitate fast access to data. However, on-chip, fast access memory may be limited in size compared to other memory (e.g., the system memory 404). As such, efficient and dynamic memory management across time may facilitate maximizing power and performance savings.

An application (e.g., a video game application) may submit workloads in an order that is suitable for the application. A workload may refer to a discrete unit of work. In an example, a workload may be a shadow pass, that is, a workload may be associated with determining which geometries are behind or in front of a light source. In another example, a workload may be a lighting pass in which scene geometry is colored based on previous shadow and lighting work. In yet another example, a workload may be a post-processing pass (e.g., a bloom pass, a Gaussian blur pass, etc.) that operates on a fully lit scene (e.g., a scene lit by a lighting pass). A graphics processor workload may refer to workload performed by a graphics processor. However, the application may not have information pertaining to how a GPU driver (e.g., a GPU driver associated with the GPU 402) may suitably persist frequently and/or recently used resources (e.g., textures) in on-chip memory (e.g., the GPU memory 406) in order to prevent the resources from being placed off-chip (e.g., in the system memory 404). Reading and/or writing resources off-chip (e.g., from/to the system memory 404) may be associated with increased power consumption, reduced read/write speed, and/or decreased performance.

In the example 502, an application (not depicted in FIG. 5) may provide a GPU (e.g., the GPU 402) with a first workload 504 (or an indication thereof), a second workload 506 (or an indication thereof), and a third workload 508 (or an indication thereof. In the example 502, the GPU may execute the first workload 504, the second workload 506, and the third workload 508 sequentially, that is, the GPU may execute the first workload 504, followed by the second workload 506, followed by the third workload 508.

The first workload 504, when executed by the GPU, may write (i.e., produce) a first resource 510 (e.g., a first texture, such as the previously generated texture 408, a render target, etc.) to GMEM 512 (e.g., the GPU memory 406). In an example, the first workload 504 may include rendering a texture at a first resolution. A texture may refer to an image that is sampled from to provide a surface (e.g., a two-dimensional (2D) surface, a three-dimensional (3D) surface) with visual characteristics (e.g., bumps, repeated patterns, etc.). A render target may refer to a resource into which primitives are rasterized and shaded. (e.g., a frame buffer or texture map). For instance, a render target may be a section of memory in which the next frame to be displayed is drawn. The second workload 506, when executed by the GPU, may write (i.e., produce) a second resource 514 to the GMEM 512. However, as the GMEM 512 may have a limited size, the GMEM 512 may not be able to simultaneously store both the first resource 510 and the second resource 514. As such, in order to perform the second workload 506, the GPU may evict (i.e., write) the first resource 510 to system memory (e.g., the system memory 404) and remove the first resource 510 from the GMEM 512. The GPU may then write (as part of the second workload 506) the second resource 514. In an example, the second workload 506 may include adding Gaussian blur to the texture rendered at the first resolution. In an example, the second resource 514 may be consumed by another workload (not depicted in FIG. 5) and the GMEM 512 may then be empty. The third workload 508, when executed by the GPU, may read (i.e., consume) the first resource 510. However, as the first resource was evicted to the system memory, the GPU may perform an off-chip read (from the system memory) to read the first resource 510. In an example, the third workload 508 may include upscaling the texture from the first resolution to a second resolution, where the second resolution is greater than the first resolution.

The workload order described in the example 502 may be not be suitable for the GPU, as producing the second resource 514 may spatially prevent the first resource 510 from staying (i.e., persisting) on-chip (e.g., in the GMEM 512) for both the first workload 504 and the third workload 508. Thus, as described above, the workload order described in the example 502 may cause the first resource 510 to be evicted to off-chip memory (e.g., the system memory 404). The eviction may be associated with an increased power consumption at the GPU and/or reduced performance. Scenarios similar to the example 502 may be observed at scale. Furthermore, scenarios similar to the example 502 may be observed across longer periods of workloads (e.g., six workloads, ten workloads, etc.).

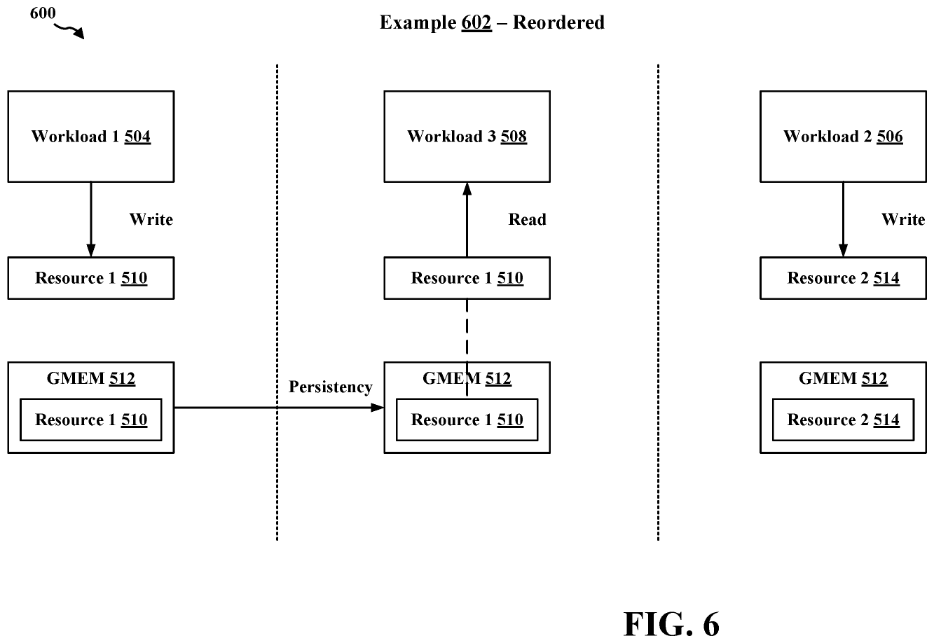

FIG. 6 is a diagram 600 illustrating an example 602 of reordered graphics processor workloads in accordance with one or more techniques of this disclosure. Aspects presented herein may pertain to reordering GPU workloads that produce and use the same resource into a more tightly coupled sequence. As such, an application may submit workloads in an order that is natural to the application. A GPU driver may generate a workload dependency graph based on the submitted workloads in order to determine (i.e., “gain an understanding”) of resource producers (i.e., workloads that produce resources) and resource consumers (i.e., workloads that consume resources). The GPU driver may move resource consumers as close to resource producers as possible. Stated differently, the GPU driver may reorder workloads based on the resource consumers and the resource producers. Reordering the workloads in such a manner may preserve a functional ordering of the workloads. For instance, workloads may be reordered such that a workload that consumes a resource will not be reordered before a workload that produces the resource. Furthermore, the reordering described herein may maximize a number of scenarios in which back-to-back workloads all consume the same resource(s) produced by an immediately preceding workload. The reordering described herein may lead to multi-workload chains that cause multiple resources to be persisted on-chip.

In the example 602, a GPU driver of a GPU (e.g., the GPU 402) may obtain an indication of the first workload 504, the second workload 506, and the third workload 508 from an application (e.g., a video game). The GPU driver may analyze the dependencies between the first workload 504, the second workload 506, and the third workload 508. For instance, the GPU driver may generate a dependency graph that is indicative of dependencies of resources produced and/or consumed by the first workload 504, the second workload 506, and the third workload 508. Based on the analysis (and/or the dependency graph), the GPU driver may reorder the first workload 504, the second workload 506, and the third workload 508. For example, as (1) the first workload 504 writes the first resource 510 to the GMEM 512 and the third workload 508 reads the first resource 510 from the GMEM 512, and (2) the second workload 506 writes the second resource 514 to the GMEM 512, the GPU driver may reorder the first workload 504, the second workload 506, and the third workload 508 such that the first workload 504 is executed first, the third workload 508 is executed second, and the second workload 506 is executed third.

The GPU may execute the workloads in the ordered indicated by the GPU driver. In the example 602, when executed by the GPU, the first workload 504 writes (i.e., produces) the first resource 510 to the GMEM 512. Next, when executed by the GPU, the third workload 508 reads (i.e., consumes) the first resource 510 from the GMEM. The first resource 510 may then be removed from the GMEM 512. Next, when executed by the GPU, the second workload 506 writes the second resource 514 to the GMEM 512. In comparison to the example 502, the example 602 may prevent the first resource 510 from being evicted to off-chip memory (e.g., the system memory 404). Thus, the example 602 may be associated with reduced power consumption, increased performance, etc. in comparison to power consumption/performance associated with the example 502.

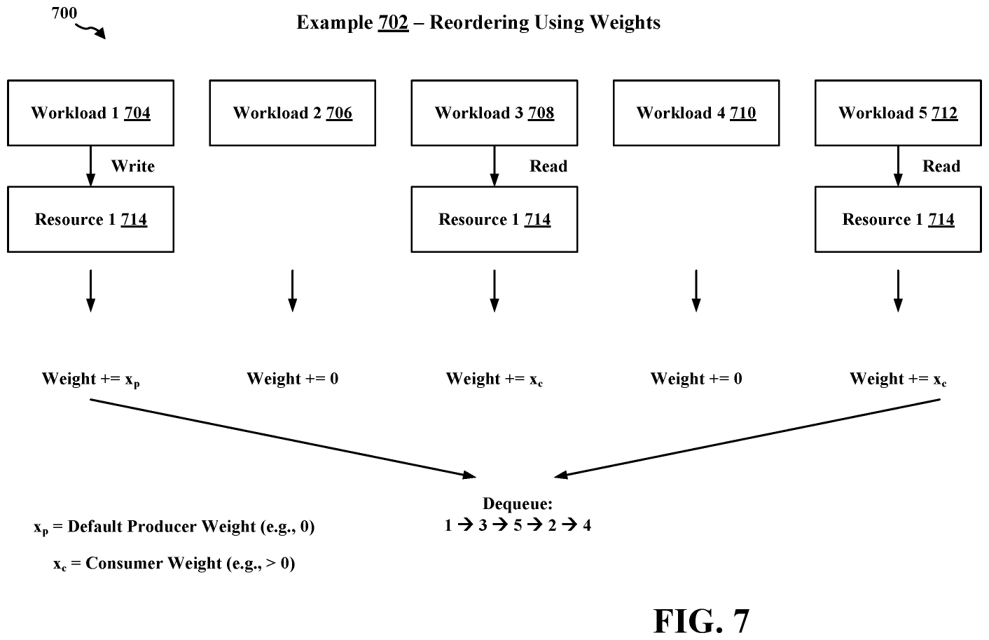

FIG. 7 is a diagram 700 illustrating an example 702 of reordering graphics processor workloads using weights in accordance with one or more techniques of this disclosure. In the example 702, a GPU driver of a GPU (e.g., the GPU 402) may receive, from an application (e.g., a video game), an indication of a first workload 704, an indication of a second workload 706, an indication of a third workload 708, an indication of a fourth workload 710, and an indication of a fifth workload 712. The first workload 704, the second workload 706, the third workload 708, the fourth workload 710, and the fifth workload 712 may be referred to as the workloads 704-712. In an example, the GPU driver may receive the indication of the first workload 704, the indication of the first workload 704, the indication of the second workload 706, the indication of the third workload 708, the indication of the fourth workload 710, and the indication of the fifth workload 712 sequentially. In an example, the first workload 704 may write a first resource 714 to GMEM (e.g., the GPU memory 406), the third workload 708 may read the first resource 714 from the GMEM, and the fifth workload 712 may also read the first resource 714 (or a modified version thereof) from the GMEM. The second workload 706 and the fourth workload 710 may operate on other resources (not depicted in FIG. 7).

The GPU driver may analyze the dependencies of the workloads 704-712. Based on the analysis, the GPU driver may assign weights (i.e., values) to each of the workloads 704-712. In an example, as the first workload 704 produces the first resource 714, the GPU driver may assign a default producer weight (xₚ) to the first workload 704. In an example, the default producer weight may be zero. As the second workload 706 and the fourth workload 710 do not produce or consume the first resource 714, the GPU driver may assign a weight of zero to each of the second workload 706 and the fourth workload 710. As the third workload 708 and the fifth workload 712 consume the first resource 714, the GPU driver may assign a consumer weight (x_{c}) to the third workload 708 and the fifth workload 712. In an example, the consumer weight may be a value that is greater than zero.

The GPU driver may provide indications of the workloads 704-712 and respective weights of the workloads 704-712 to a priority queue. A priority queue may refer to a data structure in which each element in the data structure is associated with a priority value (i.e., a weight) and in which each element is dequeued from the data structure based on a respective priority value. A weight may be a value that is indicative of a relative importance of an element. The priority queue may output indications of the workloads 704-712 based on the respective weights of the workloads 704-712. In an example, the priority queue may output/indicate the following order of the workloads 704-712: the first workload 704 (i.e., a producing workload), the third workload 708 (i.e., a consuming workload), the fifth workload (i.e., a consuming workload), the second workload 706 (i.e., a workload not associated with producing or consuming the first resource 714), and the fourth workload 710 (i.e., a workload not associated with producing or consuming the first resource 714). The GPU driver may then cause the GPU to execute the workloads 704-712 in the aforementioned order. As the third workload 708 and the fifth workload 712 (consuming workloads) have been reordered to be placed subsequent to first workload 704 without intervening workload(s), the example 702 may be associated with a reduced number of off-chip transactions, which may reduce power consumption of the GPU and/or improve performance.

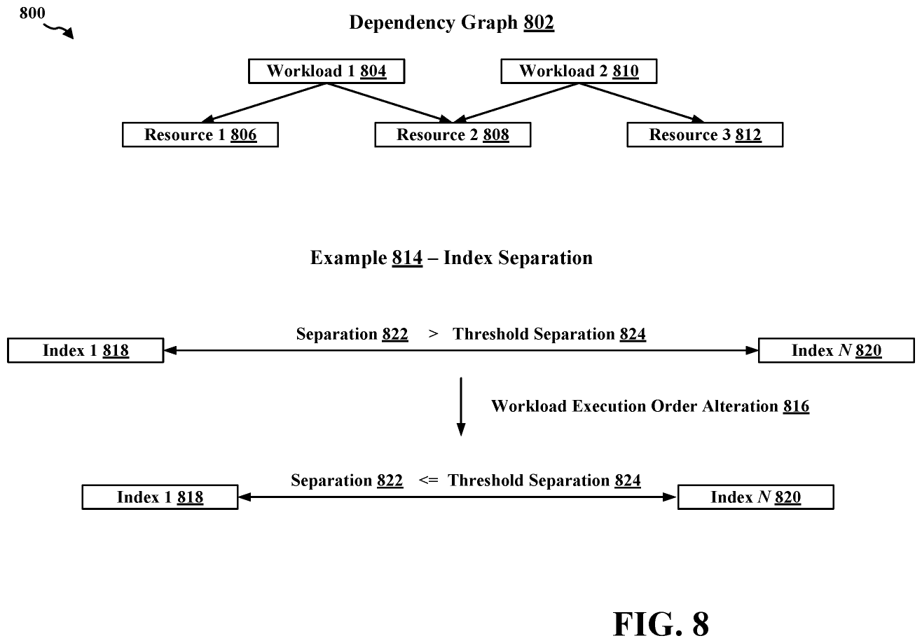

FIG. 8 is a diagram 800 illustrating example aspects pertaining to reordering graphics processor workloads in accordance with one or more techniques of this disclosure. As indicated above, a GPU driver of a GPU (e.g., the GPU 402) may generate a dependency graph 802 in order to determine how to reorder a set of workloads. A dependency graph may refer to a directed graph that represents dependencies of different objects toward one another. The dependency graph 802 may indicate that a first workload 804 depends on a first resource 806 and a second resource 808. The dependency graph 802 may also indicate that a second workload 810 may depend on the second resource 808 and a third resource 812.

In one aspect, when performing reordering an execution order of workloads, a GPU driver may reorder the execution order such that indices of workloads are within a threshold index of one another. In an example 814, a first workload may be associated with a first index 818 and an Nth workload may be associated with an Nth index 820, where N is a positive integer greater than one. Prior to a workload execution order alteration 816 (i.e., a reordering), a separation 822 (i.e., a number of indices between the first index and the Nth index 820) may be greater than a threshold separation 824 (i.e., a threshold number of indices). The separation 822 may also be referred to as an index separation. The GPU driver may perform the workload execution order alteration 816. The workload execution order alteration 816 may adjust the separation 822 such that the separation 822 is less than or equal to the threshold separation 824.

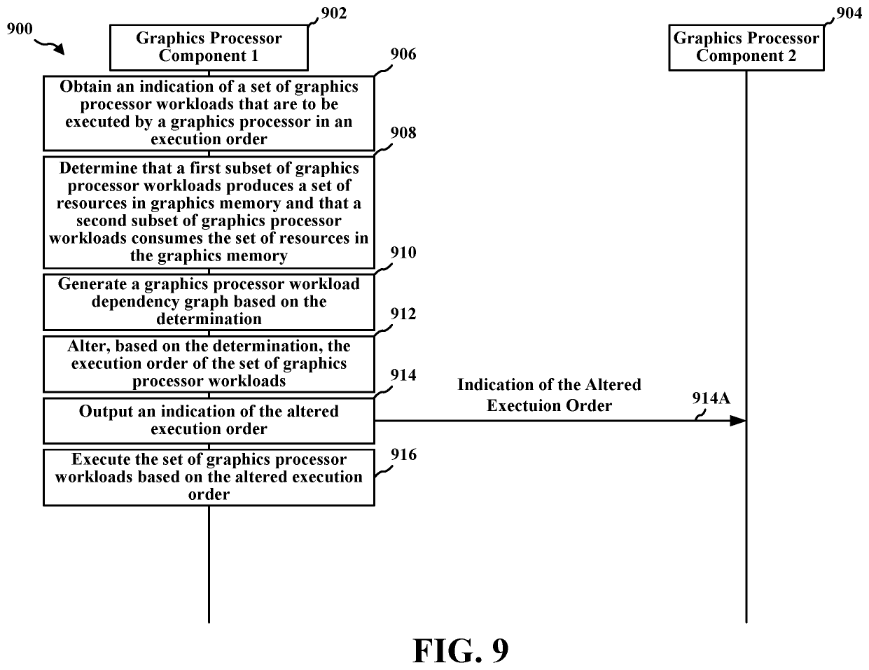

FIG. 9 is a call flow diagram 900 illustrating example communications between a first graphics processor component 902 and a second graphics processor component 904 in accordance with one or more techniques of this disclosure. In an example, the first graphics processor component 902 and the second graphics processor component 904 may be included in the device. In one example, the first graphics processor component 902 and/or the second graphics processor component 904 may be a GPU (e.g., the GPU 402) or part of the GPU (e.g., part of the GPU 402). In another example, the first graphics processor component 902 and/or the second graphics processor component 904 may be GPU driver software executed by a CPU. In a further example, the first graphics processor component 902 may be GPU driver software executed by a CPU and the second graphics processor component 904 may be a GPU.

At 906, the first graphics processor component 902 may obtain an indication of a set of graphics processor workloads that are to be executed by a graphics processor in an execution order. At 908, the first graphics processor component 902 may determine that a first subset of graphics processor workloads in the set of graphics processor workloads produces a set of resources in graphics memory and that a second subset of graphics processor workloads in the set of graphics processor workloads consumes the set of resources in the graphics memory. At 912, the first graphics processor component 902 may alter, based on the determination at 908, the execution order of the set of graphics processor workloads such that a first index of the first subset of graphics processor workloads occurs within a threshold index separation from a second index of the second subset of graphics processor workloads. At 914, the first graphics processor component 902 may output an indication of the altered execution order. For example, at 914A, the first graphics processor component 902 may transmit (e.g., to the second graphics processor component 904) the indication of the altered execution order.

At 910, the first graphics processor component 902 may generate a graphics processor workload dependency graph based on the determination at 908 that the first subset of graphics processor workloads produces the set of resources and that the second subset of graphics processor workloads consumes the set of resources, and where altering the execution order of the set of graphics processor workloads at 912 includes altering the execution order of the set of graphics processor workloads further based on the graphics processor workload dependency graph such that dependencies indicated by the dependency graph are not violated.

At 916, the first graphics processor component 902 may execute the set of graphics processor workloads based on the altered execution order. In one aspect in which the first graphics processor component 902 is GPU driver software executed by a CPU and the second graphics processor component 904 is a GPU, the second graphics processor component 904 may execute the set of graphics processor workloads based on the altered execution order (transmitted by the first graphics processor component 902 at 914A).

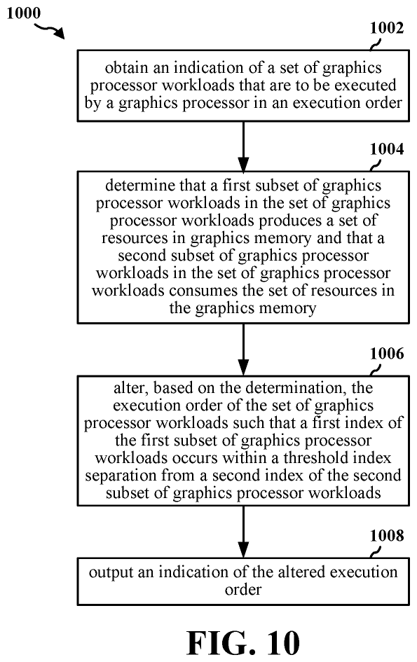

FIG. 10 is a flowchart 1000 of an example method of graphics processing in accordance with one or more techniques of this disclosure. The method may be performed by an apparatus, such as an apparatus for graphics processing, a GPU (e.g., the GPU 402), the first graphics processor component 902, the second graphics processor component 904, a CPU, GPU driver software executed by a CPU, the device 104, a wireless communication device, and the like, as used in connection with the aspects of FIGS. 1-9. In an example, the method may be performed by the workload adjuster 198.

At 1002, the apparatus obtains an indication of a set of graphics processor workloads that are to be executed by a graphics processor in an execution order. For example, FIG. 9 at 906 shows that the first graphics processor component 902 may obtain an indication of a set of graphics processor workloads that are to be executed by a graphics processor in an execution order. In an example, the set of graphics processor workloads may include the first workload 504, the second workload 506, and the third workload 508. In an example, the execution order may be the order illustrated in the example 502. In another example, the set of graphics processor workloads may include the first workload 704, the second workload 706, the third workload 708, the fourth workload 710, and the fifth workload 712. In an example, the graphics processor may be or include the GPU 200 or the GPU 402. In an example, 1002 may be performed by the workload adjuster 198.

At 1004, the apparatus determines that a first subset of graphics processor workloads in the set of graphics processor workloads produces a set of resources in graphics memory and that a second subset of graphics processor workloads in the set of graphics processor workloads consumes the set of resources in the graphics memory. For example, FIG. 9 at 908 shows that the first graphics processor component 902 may determine that a first subset of graphics processor workloads in the set of graphics processor workloads produces a set of resources in graphics memory and that a second subset of graphics processor workloads in the set of graphics processor workloads consumes the set of resources in the graphics memory. In an example, the graphics memory may be or include the GPU memory 406, the internal memory 121, or the GMEM 512. In an example, the first subset may include the first workload 504 and the second workload 506, and the second subset may include the third workload 508. In an example, the set of resources may include the first resource 510 and the second resource 514. In another example, the first subset may be or include the first workload 704 and the second subset may be or include the third workload 708 and the fifth workload 712. In an example, the set of resources may include the first resource 714. In an example, 1004 may be performed by the workload adjuster 198.

At 1006, the apparatus alters, based on the determination, the execution order of the set of graphics processor workloads such that a first index of the first subset of graphics processor workloads occurs within a threshold index separation from a second index of the second subset of graphics processor workloads. For example, FIG. 9 at 912 shows that the first graphics processor component 902 may alter, based on the determination, the execution order of the set of graphics processor workloads such that a first index of the first subset of graphics processor workloads occurs within a threshold index separation from a second index of the second subset of graphics processor workloads. In an example, the (altered) execution order may correspond to the example 602 in FIG. 6. In an example, the first index may be the first index 818 and the second index may be the Nth index 820. In an example, the threshold index separation may include or may be associated with the threshold separation 824. In an example, 1006 may be performed by the workload adjuster 198.

At 1008, the apparatus outputs an indication of the altered execution order. For example, FIG. 9 at 914 shows that the first graphics processor component 902 may output an indication of the altered execution order. In an example, 1008 may be performed by the workload adjuster 198.

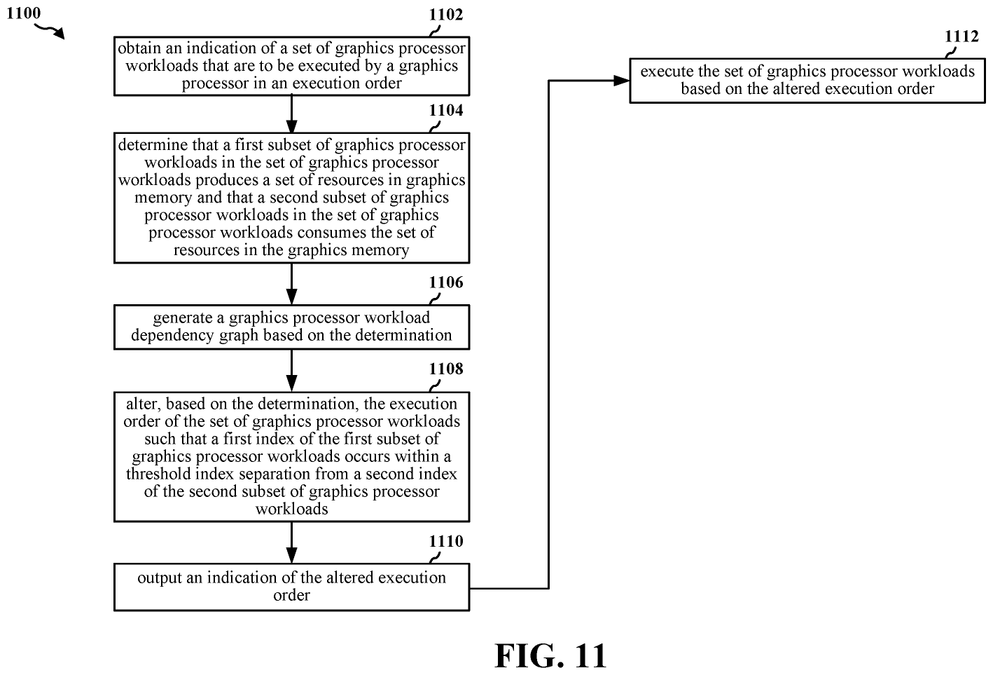

FIG. 11 is a flowchart 1100 of an example method of graphics processing in accordance with one or more techniques of this disclosure. The method may be performed by an apparatus, such as an apparatus for graphics processing, a GPU (e.g., the GPU 402), the first graphics processor component 902, the second graphics processor component 904, a CPU, GPU driver software executed by a CPU, the device 104, a wireless communication device, and the like, as used in connection with the aspects of FIGS. 1-9. In an example, the method (including the various aspects detailed below) may be performed by the workload adjuster 198.

At 1102, the apparatus obtains an indication of a set of graphics processor workloads that are to be executed by a graphics processor in an execution order. For example, FIG. 9 at 906 shows that the first graphics processor component 902 may obtain an indication of a set of graphics processor workloads that are to be executed by a graphics processor in an execution order. In an example, the set of graphics processor workloads may include the first workload 504, the second workload 506, and the third workload 508. In an example, the execution order may be the order illustrated in the example 502. In another example, the set of graphics processor workloads may include the first workload 704, the second workload 706, the third workload 708, the fourth workload 710, and the fifth workload 712. In an example, the graphics processor may be or include the GPU 200 or the GPU 402. In an example, 1102 may be performed by the workload adjuster 198.

At 1104, the apparatus determines that a first subset of graphics processor workloads in the set of graphics processor workloads produces a set of resources in graphics memory and that a second subset of graphics processor workloads in the set of graphics processor workloads consumes the set of resources in the graphics memory. For example, FIG. 9 at 908 shows that the first graphics processor component 902 may determine that a first subset of graphics processor workloads in the set of graphics processor workloads produces a set of resources in graphics memory and that a second subset of graphics processor workloads in the set of graphics processor workloads consumes the set of resources in the graphics memory. In an example, the graphics memory may be or include the GPU memory 406, the internal memory 121, or the GMEM 512. In an example, the first subset may include the first workload 504 and the second workload 506, and the second subset may include the third workload 508. In an example, the set of resources may include the first resource 510 and the second resource 514. In another example, the first subset may be or include the first workload 704 and the second subset may be or include the third workload 708 and the fifth workload 712. In an example, the set of resources may include the first resource 714. In an example, 1104 may be performed by the workload adjuster 198.

At 1108, the apparatus alters, based on the determination, the execution order of the set of graphics processor workloads such that a first index of the first subset of graphics processor workloads occurs within a threshold index separation from a second index of the second subset of graphics processor workloads. For example, FIG. 9 at 912 shows that the first graphics processor component 902 may alter, based on the determination, the execution order of the set of graphics processor workloads such that a first index of the first subset of graphics processor workloads occurs within a threshold index separation from a second index of the second subset of graphics processor workloads. In an example, the (altered) execution order may correspond to the example 602 in FIG. 6. In an example, the first index may be the first index 818 and the second index may be the Nth index 820. In an example, the threshold index separation may include or may be associated with the threshold separation 824. In an example, 1108 may be performed by the workload adjuster 198.

At 1110, the apparatus outputs an indication of the altered execution order. For example, FIG. 9 at 914 shows that the first graphics processor component 902 may output an indication of the altered execution order. In an example, 1110 may be performed by the workload adjuster 198.

In one aspect, altering the execution order of the set of graphics processor workloads may include altering the execution order such that an execution of the first subset of graphics processor workloads is prior to an execution of the second subset of graphics processor workloads. For example, the aforementioned aspect may correspond to the example 602 in FIG. 6.

In one aspect, at 1106, the apparatus may generate a graphics processor workload dependency graph based on the determination that the first subset of graphics processor workloads produces the set of resources and that the second subset of graphics processor workloads consumes the set of resources, and where altering the execution order of the set of graphics processor workloads may include altering the execution order of the set of graphics processor workloads further based on the graphics processor workload dependency graph such that dependencies indicated by the dependency graph are not violated. For example, FIG. 9 at 910 shows that the first graphics processor component 902 may generate a graphics processor workload dependency graph based on the determination that the first subset of graphics processor workloads produces the set of resources and that the second subset of graphics processor workloads consumes the set of resources, and where altering the execution order of the set of graphics processor workloads may include altering the execution order of the set of graphics processor workloads further based on the graphics processor workload dependency graph such that dependencies indicated by the dependency graph are not violated. In an example, the graphics processor workload dependency graph may be or include the dependency graph 802. In an example, 1106 may be performed by the workload adjuster 198.

In one aspect, the altered execution order may result in a chain of commands associated with outputs that are produced in the graphics memory or consumed entirely in the graphics memory. For example, altering the execution order at 912 may result in a chain of commands associated with outputs that are produced in the graphics memory or consumed entirely in the graphics memory.

In one aspect, outputting the indication of the altered execution order may include: storing the indication of the altered execution order in at least one of a memory, a buffer, or a cache; or transmitting the indication of the altered execution order. For example, outputting the indication of the altered execution order at 914 may include: storing the indication of the altered execution order in at least one of a memory, a buffer, or a cache. In another example, FIG. 9 at 914A shows that the first graphics processor component 902 may transmit the indication of the altered execution order (e.g., to the second graphics processor component 904).

In one aspect, the execution order may indicate that a first graphics processor workload in the first subset of graphics processor workloads, a second graphics processor workload in the first subset of graphics processor workloads, and a third graphics processor workload in the second subset of graphics processor workloads are to be executed sequentially, and where the altered execution order may indicate that the first graphics processor workload, the third graphics processor workload, and the second graphics processor workload are to be executed sequentially. For example, the execution order may correspond to the example 502 in FIG. 5 and the altered execution order may correspond to the example 602 in FIG. 6.

In one aspect, the execution order may indicate that a first graphics processor workload in the first subset of graphics processor workloads, a second graphics processor workload in the second subset of graphics processor workloads, a third graphics processor workload in the first subset of graphics processor workloads, and a fourth graphics processor workload in the second subset of graphics processor workloads are to be executed sequentially, and where the altered execution order may indicate that the first graphics processor workload, the second graphics processor workload, the fourth graphics processor workload, and the third graphics processor workload are to be executed sequentially. For example, the execution order at 906 may indicate that a first graphics processor workload in the first subset of graphics processor workloads, a second graphics processor workload in the second subset of graphics processor workloads, a third graphics processor workload in the first subset of graphics processor workloads, and a fourth graphics processor workload in the second subset of graphics processor workloads are to be executed sequentially and the altered execution order at 912 may indicate that the first graphics processor workload, the second graphics processor workload, the fourth graphics processor workload, and the third graphics processor workload are to be executed sequentially.

In one aspect, the set of resources may include at least one of a set of textures or a set of render targets. In an example, the first resource 510 and the second resource 514 may be included in a set of textures. In another example, the first resource 510 and the second resource 514 may be included in a set of render targets.

In one aspect, at 1112, the apparatus may execute the set of graphics processor workloads based on the altered execution order. For example, FIG. 9 at 916 shows that the first graphics processor component 902 may execute the set of graphics processor workloads based on the altered execution order. In another aspect, the second graphics processor component 904 may execute the set of graphics processor workloads based on the altered execution order. In an example, 1112 may be performed by the workload adjuster 198.

In one aspect, altering the execution order of the set of graphics processor workloads may include: assigning a set of weights to the set of graphics processor workloads; enqueueing the set of graphics processor workloads to a priority queue based on the assigned set of weights; and dequeuing the set of graphics processor workloads from the priority queue, where the altered execution order may be based on the dequeued set of workloads. In an example, the aforementioned aspect may correspond to the example 702.

In one aspect, the set of weights may include a first weight associated with the first subset of graphics processor workloads and a second weight associated with the second subset of graphics processor workloads, and where the second weight may be greater than the first weight. In an example, the first weight may be a default producer weight as described in the description of FIG. 7 and the second weight may be a consumer weight as described in the description of FIG. 7.

In one aspect, the set of weights may include a first weight associated with the first subset of graphics processor workloads and a second weight associated with the second subset of graphics processor workloads, and where the second weight may be less than the first weight. In an example, the aforementioned aspect may correspond to the example 702.

In one aspect, the obtained indication of the set of graphics processor workloads that are to be executed by the graphics processor in the execution order may indicate that the first index of the first subset of graphics processor workloads occurs outside of the threshold index separation from the second index of the second subset of graphics processor workloads. For example, the indication of the set of graphics processor workloads obtained at 906 may indicate that the first index of the first subset of graphics processor workloads occurs outside of the threshold index separation from the second index of the second subset of graphics processor workloads. In another example, FIG. 8 shows that the separation 822 may be greater than the threshold separation 824 prior to the workload execution order alteration 816.

In one aspect, the altered execution order may minimize a number of off-chip evictions of the set of resources from the graphics memory to system memory. For example, the execution order altered at 912 may minimize a number of off-chip evictions of the set of resources from the graphics memory to system memory. In another example, the aforementioned aspect may correspond to aspects described above in connection with FIG. 4. For instance, the graphics memory may be the GPU memory 406 and the system memory may be the system memory 404. In another example, the system memory may be the system memory 124 or the system memory 240.

In one aspect, obtaining the indication of the set of graphics processor workloads may include obtaining the indication of the set of graphics processor workloads from an application, and where altering the execution order of the set of graphics processor workloads may include altering the execution order of the set of graphics processor workloads via a graphics processor driver. For example, obtaining the indication of the set of graphics processor workloads at 906 may include obtaining the indication of the set of graphics processor workloads from an application, and altering the execution order of the set of graphics processor workloads at 912 may include altering the execution order of the set of graphics processor workloads via a graphics processor driver.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining an indication of a set of graphics processor workloads that are to be executed by a graphics processor in an execution order. The apparatus may further include means for determining that a first subset of graphics processor workloads in the set of graphics processor workloads produces a set of resources in graphics memory and that a second subset of graphics processor workloads in the set of graphics processor workloads consumes the set of resources in the graphics memory. The apparatus may further include means for altering, based on the determination, the execution order of the set of graphics processor workloads such that a first index of the first subset of graphics processor workloads occurs within a threshold index separation from a second index of the second subset of graphics processor workloads. The apparatus may further include means for outputting an indication of the altered execution order. The apparatus may further include means for generating a graphics processor workload dependency graph based on the determination that the first subset of graphics processor workloads produces the set of resources and that the second subset of graphics processor workloads consumes the set of resources, and where altering the execution order of the set of graphics processor workloads includes altering the execution order of the set of graphics processor workloads further based on the graphics processor workload dependency graph such that dependencies indicated by the dependency graph are not violated. The apparatus may further include means for executing the set of graphics processor workloads based on the altered execution order.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, including: obtaining an indication of a set of graphics processor workloads that are to be executed by a graphics processor in an execution order; determining that a first subset of graphics processor workloads in the set of graphics processor workloads produces a set of resources in graphics memory and that a second subset of graphics processor workloads in the set of graphics processor workloads consumes the set of resources in the graphics memory; altering, based on the determination, the execution order of the set of graphics processor workloads such that a first index of the first subset of graphics processor workloads occurs within a threshold index separation from a second index of the second subset of graphics processor workloads; and outputting an indication of the altered execution order.

Aspect 2 may be combined with aspect 1, wherein altering the execution order of the set of graphics processor workloads includes altering the execution order such that an execution of the first subset of graphics processor workloads is prior to an execution of the second subset of graphics processor workloads.

Aspect 3 may be combined with any of aspects 1-2, further including: generating a graphics processor workload dependency graph based on the determination that the first subset of graphics processor workloads produces the set of resources and that the second subset of graphics processor workloads consumes the set of resources, and wherein altering the execution order of the set of graphics processor workloads includes altering the execution order of the set of graphics processor workloads further based on the graphics processor workload dependency graph such that dependencies indicated by the dependency graph are not violated.

Aspect 4 may be combined with any of aspects 1-3, wherein the altered execution order results in a chain of commands associated with outputs that are produced in the graphics memory or consumed entirely in the graphics memory.

Aspect 5 may be combined with any of aspects 1-4, wherein outputting the indication of the altered execution order includes: storing the indication of the altered execution order in at least one of a memory, a buffer, or a cache; or transmitting the indication of the altered execution order.

Aspect 6 may be combined with any of aspects 1-5, wherein the execution order indicates that a first graphics processor workload in the first subset of graphics processor workloads, a second graphics processor workload in the first subset of graphics processor workloads, and a third graphics processor workload in the second subset of graphics processor workloads are to be executed sequentially, and wherein the altered execution order indicates that the first graphics processor workload, the third graphics processor workload, and the second graphics processor workload are to be executed sequentially.

Aspect 7 may be combined with any of aspects 1-5, wherein the execution order indicates that a first graphics processor workload in the first subset of graphics processor workloads, a second graphics processor workload in the second subset of graphics processor workloads, a third graphics processor workload in the first subset of graphics processor workloads, and a fourth graphics processor workload in the second subset of graphics processor workloads are to be executed sequentially, and wherein the altered execution order indicates that the first graphics processor workload, the second graphics processor workload, the fourth graphics processor workload, and the third graphics processor workload are to be executed sequentially.

Aspect 8 may be combined with any of aspects 1-7, wherein the set of resources includes at least one of a set of textures or a set of render targets.

Aspect 9 may be combined with any of aspects 1-8, further including: executing the set of graphics processor workloads based on the altered execution order.

Aspect 10 may be combined with any of aspects 1-9, wherein altering the execution order of the set of graphics processor workloads includes: assigning a set of weights to the set of graphics processor workloads; enqueueing the set of graphics processor workloads to a priority queue based on the assigned set of weights; and dequeuing the set of graphics processor workloads from the priority queue, wherein the altered execution order is based on the dequeued set of workloads.

Aspect 11 may be combined with aspect 10, wherein the set of weights includes a first weight associated with the first subset of graphics processor workloads and a second weight associated with the second subset of graphics processor workloads, and wherein the second weight is greater than the first weight.

Aspect 12 may be combined with aspect 10, wherein the set of weights includes a first weight associated with the first subset of graphics processor workloads and a second weight associated with the second subset of graphics processor workloads, and wherein the second weight is less than the first weight.

Aspect 13 may be combined with any of aspects 1-12, wherein the obtained indication of the set of graphics processor workloads that are to be executed by the graphics processor in the execution order indicates that the first index of the first subset of graphics processor workloads occurs outside of the threshold index separation from the second index of the second subset of graphics processor workloads.

Aspect 14 may be combined with any of aspects 1-13, wherein the altered execution order minimizes a number of off-chip evictions of the set of resources from the graphics memory to system memory.

Aspect 15 may be combined with any of aspects 1-14, wherein obtaining the indication of the set of graphics processor workloads includes obtaining the indication of the set of graphics processor workloads from an application, and wherein altering the execution order of the set of graphics processor workloads includes altering the execution order of the set of graphics processor workloads via a graphics processor driver.

Aspect 16 is an apparatus for graphics/display processing including a memory and a processor coupled to the memory and, based on information stored in the memory, the processor is configured to implement a method as in any of aspects 1-15.

Aspect 17 may be combined with aspect 16 and includes that the apparatus is a wireless communication device comprising at least one of a transceiver or an antenna coupled to the processor.

Aspect 18 is an apparatus for graphics processing including means for implementing a method as in any of aspects 1-15.

Aspect 19 is a computer-readable medium (e.g., a non-transitory computer-readable medium) storing computer executable code, the computer executable code, when executed by a processor, causes the processor to implement a method as in any of aspects 1-15.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
obtain an indication of a set of graphics processor workloads that are to be executed by a graphics processor in an execution order;
determine that a first subset of graphics processor workloads in the set of graphics processor workloads produces a set of resources in graphics memory and that a second subset of graphics processor workloads in the set of graphics processor workloads consumes the set of resources in the graphics memory;
alter, based on the determination, the execution order of the set of graphics processor workloads such that a first index of the first subset of graphics processor workloads occurs within a threshold index separation from a second index of the second subset of graphics processor workloads; and
output an indication of the altered execution order.

2. The apparatus of claim 1, wherein to alter the execution order of the set of graphics processor workloads, the processor is configured to alter the execution order such that an execution of the first subset of graphics processor workloads is prior to an execution of the second subset of graphics processor workloads.

3. The apparatus of claim 1, wherein the processor is further configured to:
generate a graphics processor workload dependency graph based on the determination that the first subset of graphics processor workloads produces the set of resources and that the second subset of graphics processor workloads consumes the set of resources, and wherein to alter the execution order of the set of graphics processor workloads, the processor is configured to alter the execution order of the set of graphics processor workloads further based on the graphics processor workload dependency graph such that dependencies indicated by the dependency graph are not violated.

4. The apparatus of claim 1, wherein the altered execution order results in a chain of commands associated with outputs that are produced in the graphics memory or consumed entirely in the graphics memory.

5. The apparatus of claim 1, wherein to output the indication of the altered execution order, the processor is configured to:
store the indication of the altered execution order in at least one of the memory, a buffer, or a cache; or
transmit the indication of the altered execution order.

6. The apparatus of claim 1, wherein the execution order indicates that a first graphics processor workload in the first subset of graphics processor workloads, a second graphics processor workload in the first subset of graphics processor workloads, and a third graphics processor workload in the second subset of graphics processor workloads are to be executed sequentially, and wherein the altered execution order indicates that the first graphics processor workload, the third graphics processor workload, and the second graphics processor workload are to be executed sequentially.

7. The apparatus of claim 1, wherein the execution order indicates that a first graphics processor workload in the first subset of graphics processor workloads, a second graphics processor workload in the second subset of graphics processor workloads, a third graphics processor workload in the first subset of graphics processor workloads, and a fourth graphics processor workload in the second subset of graphics processor workloads are to be executed sequentially, and wherein the altered execution order indicates that the first graphics processor workload, the second graphics processor workload, the fourth graphics processor workload, and the third graphics processor workload are to be executed sequentially.

8. The apparatus of claim 1, wherein the set of resources comprises at least one of a set of textures or a set of render targets.

9. The apparatus of claim 1, wherein the processor is further configured to:
execute the set of graphics processor workloads based on the altered execution order.

10. The apparatus of claim 1, wherein to alter the execution order of the set of graphics processor workloads, the processor is configured to:
assign a set of weights to the set of graphics processor workloads;
enqueue the set of graphics processor workloads to a priority queue based on the assigned set of weights; and
dequeue the set of graphics processor workloads from the priority queue, wherein the altered execution order is based on the dequeued set of workloads.

11. The apparatus of claim 10, wherein the set of weights includes a first weight associated with the first subset of graphics processor workloads and a second weight associated with the second subset of graphics processor workloads, and wherein the second weight is greater than the first weight.

12. The apparatus of claim 10, wherein the set of weights includes a first weight associated with the first subset of graphics processor workloads and a second weight associated with the second subset of graphics processor workloads, and wherein the second weight is less than the first weight.

13. The apparatus of claim 1, wherein the obtained indication of the set of graphics processor workloads that are to be executed by the graphics processor in the execution order indicates that the first index of the first subset of graphics processor workloads occurs outside of the threshold index separation from the second index of the second subset of graphics processor workloads.

14. The apparatus of claim 1, wherein the altered execution order minimizes a number of off-chip evictions of the set of resources from the graphics memory to system memory.

15. The apparatus of claim 1, wherein to obtain the indication of the set of graphics processor workloads, the processor is configured to obtain the indication of the set of graphics processor workloads from an application, and wherein to alter the execution order of the set of graphics processor workloads, the processor is configured to alter the execution order of the set of graphics processor workloads via a graphics processor driver.

16. The apparatus of claim 1, wherein the apparatus is a wireless communication device comprising at least one of a transceiver or an antenna coupled to the processor.

17. A method of graphics processing, comprising:
obtaining an indication of a set of graphics processor workloads that are to be executed by a graphics processor in an execution order;
determining that a first subset of graphics processor workloads in the set of graphics processor workloads produces a set of resources in graphics memory and that a second subset of graphics processor workloads in the set of graphics processor workloads consumes the set of resources in the graphics memory;
altering, based on the determination, the execution order of the set of graphics processor workloads such that a first index of the first subset of graphics processor workloads occurs within a threshold index separation from a second index of the second subset of graphics processor workloads; and
outputting an indication of the altered execution order.

18. The method of claim 17, wherein altering the execution order of the set of graphics processor workloads comprises altering the execution order such that an execution of the first subset of graphics processor workloads is prior to an execution of the second subset of graphics processor workloads.

19. The method of claim 17, further comprising:
generating a graphics processor workload dependency graph based on the determination that the first subset of graphics processor workloads produces the set of resources and that the second subset of graphics processor workloads consumes the set of resources, and wherein altering the execution order of the set of graphics processor workloads comprises altering the execution order of the set of graphics processor workloads further based on the graphics processor workload dependency graph such that dependencies indicated by the dependency graph are not violated.

20. A computer-readable medium storing computer executable code, the computer executable code, when executed by a processor, causes the processor to:
obtain an indication of a set of graphics processor workloads that are to be executed by a graphics processor in an execution order;
determine that a first subset of graphics processor workloads in the set of graphics processor workloads produces a set of resources in graphics memory and that a second subset of graphics processor workloads in the set of graphics processor workloads consumes the set of resources in the graphics memory;
alter, based on the determination, the execution order of the set of graphics processor workloads such that a first index of the first subset of graphics processor workloads occurs within a threshold index separation from a second index of the second subset of graphics processor workloads; and
output an indication of the altered execution order.
